(19) United States
(12) Patent Application Publication
(10) Pub. No.: US 2016/0378982 A1
(43) Pub. Date: Dec. 29, 2016

(54) LOCAL ENVIRONMENT PROTECTION METHOD AND PROTECTION SYSTEM OF TERMINAL RESPONDING TO MALICIOUS CODE IN LINK INFORMATION

(71) Applicant: SOFTCAMP CO., LTD., Seoul (KR)

(72) Inventor: Steve BAE, Gyeonggi-do (KR)

(21) Appl. No.: 15/038,964

(22) PCT Filed: Dec. 5, 2014
(86) PCT No.: PCT/KR2014/011887

§ 371 Date: May 24, 2016

(30) Foreign Application Priority Data
Dec. 9, 2013 (KR) 10-2013-0152432

(51) Int. Cl. G06F 21/56

(52) U.S. Cl. CPC G06F 21/56; G06F 2221/2119

(57) ABSTRACT

A local environment protection method and system for a terminal against malicious code in link information, which are capable of preventing malicious code from being installed on a terminal without permission by selecting a text, an image, or the like included in the posted content of the body of an email, one of various webpages, or the like. The method includes a link information checking step of checking the presence of link information of content that is to be received by a general communication module and then changing a communication protocol set in the connection path information of the link information; a virtual communication module execution step of checking the content selection of a user, and executing a communication connection via the connection path of the changed communication protocol; and a content execution step of storing external data in a virtual area.

### BACKGROUND

The present invention relates to a local environment protection method and system for a terminal against malicious code in link information, which are capable of preventing malicious code from being installed on a terminal without permission by selecting a text, an image, or the like included in the posted content of the body of an email, one of various webpages, or the like.

The development of communication technology enables people to easily communicate with each other even without moving, and, furthermore, to easily obtain news of events, information and knowledge all over the world, and to process business related to various public organizations.

Accordingly, communication devices that provide such communication services have become necessities of people, and people have reliably utilized a massive amount of information provided by such communication devices.

Meanwhile, the above-described development of communication technology is accompanied by the development of malicious technology that gives a disadvantage to people by abusing the communication services of communication devices that are trusted by people. The malicious technology gives a disadvantage to a person (hereinafter the ‘user’) who uses a communication device.

The malicious technology corresponds to malicious code adapted to damage a local environment in which a communication device (hereinafter the ‘terminal’) is driven and controlled, malicious code adapted to divulge the personal information of a user, malicious code adapted to install a specific executable program, such as one of various types of adware or the like, on a terminal without permission, and the like. Meanwhile, in order for such malicious code to be executed on a terminal, there is required a data connection between a terminal and a malicious code distribution means. Accordingly, users who distribute malicious code without permission develop various types of connection paths so that terminals can connect to distribution means without hindrance.

The representative ones of the connection paths correspond to a method of setting up a website to which a distribution means is linked and allowing malicious code to be sent when a terminal connects to the website, a method of sending an email or the like, to which a distribution means is linked, without permission and allowing malicious code to be sent when a user clicks and reads the email, and the like.

Meanwhile, these technologies for distributing malicious code without permission have limitations in that the introduction of malicious code cannot be achieved unless a user attempts to perform reading or connection because the user must read an email or connect to a corresponding website through his or her selection.

In order to overcome this problem, there has been developed technology for linking a URL to the body of an email, or a text, an image or a video (hereinafter the ‘content’) in an authorized webpage or the like, to which a user has relatively small resistance, and executing an installation program at the moment the user clicks the content, thereby allowing malicious code to be installed on the terminal of the user. The content may be configured such that a URL is directly described in a text, link information is included in a general word, or link information is included in an image or a video. The user generally has a relatively small burden related to the selection (clicking) of the content due to curiosity about content and relative insensitivity to a risk. Accordingly, the user usually clicks the content without hesitation. As a result, the terminal is directly exposed to the installation program without the consent of the user, and malicious code that may damage the user is installed on the terminal and the terminal is infected with the malicious code.

In order to overcome the above problem, there has been developed technology for forcibly blocking a link of corresponding content when link information is present in the content. This technology fundamentally prevents a user from carelessly clicking the corresponding content so that a terminal of the user is infected with malicious code.

In the meantime, this conventional technology has the problem of causing inconvenience to a user because it blocks not only malicious links but also links useful for the user without distinction en bloc. Furthermore, a problem arises in that a user suffers from inconvenience in the use of a data network using authorized link information because a corresponding link is also blocked even when it is necessary to collect new information or receive update information using the link information.

### SUMMARY OF THE INVENTION

Accordingly, the present invention is contrived to overcome the above-described problems, and an object of the present invention is to provide a local environment protection method and system for a terminal against malicious code in link information, which enable a user to easily collect online information by clicking a text including link information without a burden and which can overcome the problem in which a terminal of the user is infected with various types of malicious code included in the link information.

In order to accomplish the above object, the present invention provides a local environment protection method for a terminal against malicious code in link information, the method including:

a link information checking step of checking the presence of the link information of content that is to be received by a general communication module and then changing a communication protocol set in the connection path information of the link information;

a virtual communication module execution step of checking, by a virtual communication module, the content selection of a user, and executing, by the virtual communication module, a communication connection via the connection path of the changed communication protocol; and

a content execution step of storing external data, received by the virtual communication module via the connection path, in a virtual area generated in a terminal.

In order to accomplish the above object, the present invention provides a local environment protection system for a terminal against malicious code in link information, the system including:

a link information checking module configured to check the presence of link information of content data that is to be received by a general communication module, and to change a communication protocol set in the connection path information of the link information; and

a virtual communication module configured to check the content selection of a user and execute a communication connection via the connection path of the changed communication protocol, and to store external data, received via the connection path, in a virtual area generated in a terminal.

The above-described present invention is advantageous in that a user can easily collect online information by clicking a text including link information without a burden, in that the user can receive and process external information via a terminal without intervention, and in that the problem in which the local environment of a terminal is infected with various types of malicious code included in the link information can be overcome.

### BRIEF DESCRIPTION OF DRAWINGS

FIG. 1 is a block diagram showing an embodiment of an apparatus constituting a part of a local environment protection system according to the present invention;

FIG. 2 is a flowchart sequentially showing a local environment protection method according to the present invention;

FIG. 3 shows an example of registry editing for the operation of a local environment protection system according to the present invention; and

FIG. 4 is a block diagram showing another embodiment of an apparatus constituting a part of a local environment protection system according to the present invention.

### DESCRIPTION OF REFERENCE SYMBOLS

10: terminal
10a: first terminal
10b: second terminal
11: general communication module
12: link information checking module
13: virtual area management module
14: virtual communication module
20: server

### DETAILED DESCRIPTION OF THE INVENTION

The above-described features and effects of the present invention will be more apparent from the following detailed description taken in conjunction with the accompanying drawings, and, accordingly, those having ordinary knowledge in the art to which the present invention pertains can easily practice the technical spirit of the present invention. Although various modifications may be made to the present invention and the present invention may have various forms, specific embodiments will be illustrated in the drawings and will be described in the following description in detail. However, it should be appreciated that this is not intended to limit the present invention to specific disclosed forms but the present invention includes all modifications, equivalents and substitutions included in the spirit and technical scope of the present invention. The terms used herein are used merely to describe specific embodiments, and are not intended to limit the present invention.

Specific content for the practice of the present invention will be described in detail below with reference to the accompanying drawings.

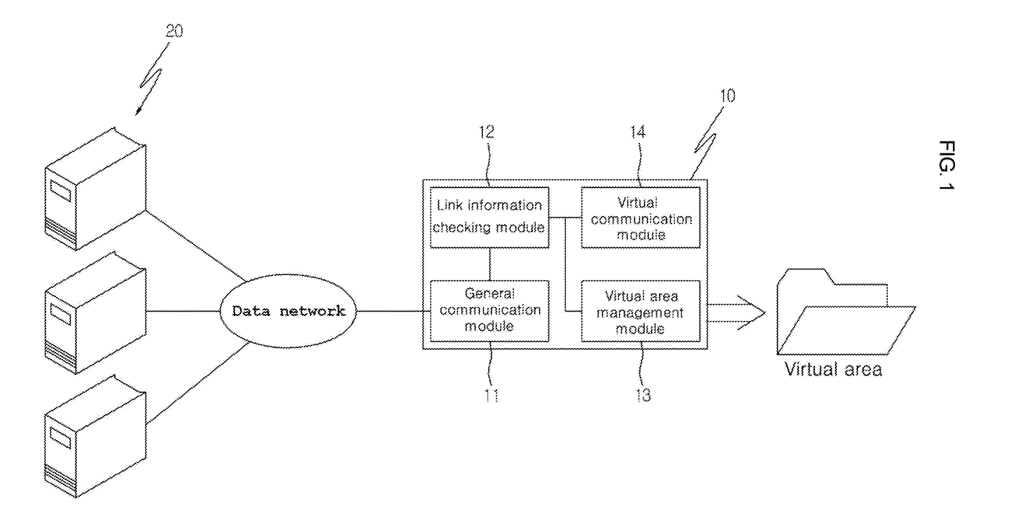

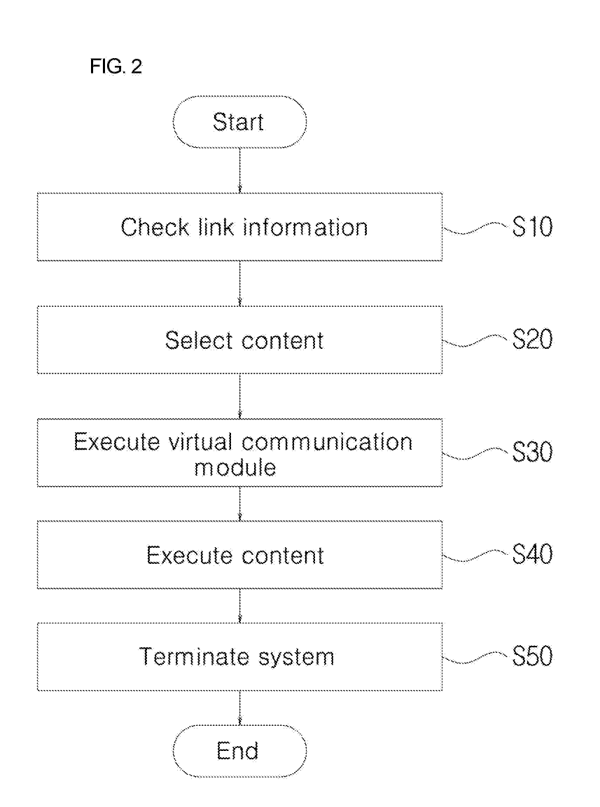

FIG. 1 is a block diagram showing an embodiment of an apparatus constituting a part of a local environment protection system according to the present invention, and FIG. 2 is a flowchart sequentially showing a local environment protection method according to the present invention. The following description is given with reference to these drawings.

The local environment protection system according to the present invention is installed in a terminal 10, and checks the link information of content transferred over a data network and then allows the link information to be securely processed in the terminal 10. For this purpose, the local environment protection system includes a link information checking module 12 configured to check the link information of content that is to be received by the terminal 10, a virtual area management module 13 configured to generate a virtual area in the terminal 10 and confine the execution space of the link information, and a virtual communication module 14 configured to process the execution of the link information.

The link information checking module 12 checks the data of the content received by the terminal 10 while a communication program, such as a web browser, a mail system, an FTP, or the like (hereinafter the ‘general communication module’), is operating, and checks the presence of the link information in the data of the content. The link information includes a URL (uniform resource locator) or the like in the form of http or ftp that is connection path information for another website. The link information checking module 12 checks the connection path information by checking the link information.

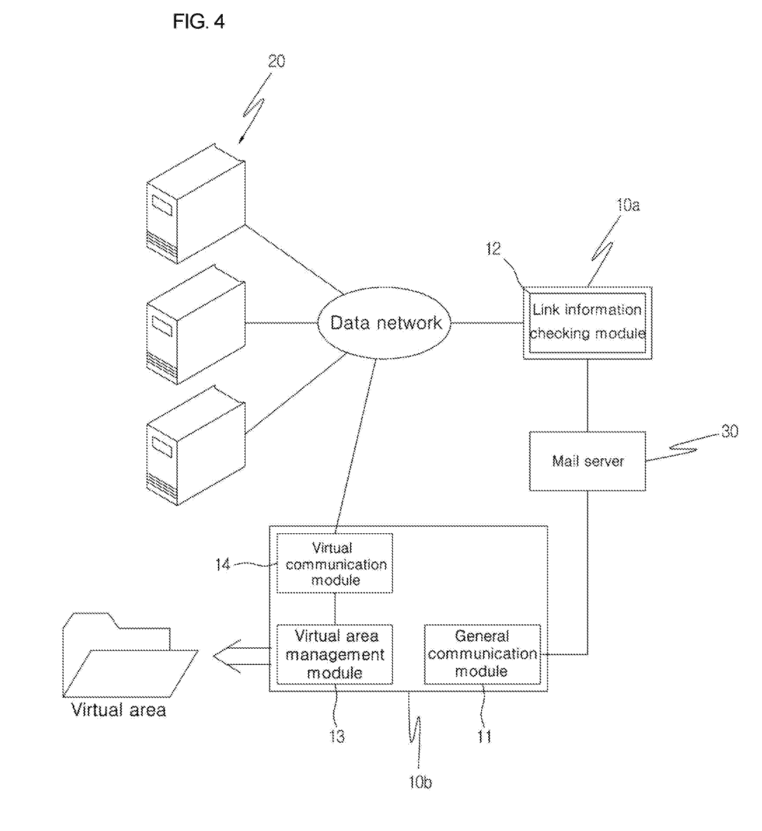

When the protection system according to the present invention is integrated in the terminal 10, the virtual area management module 13 generates the virtual area in the terminal 10 when the terminal 10 is booted or when a generation signal transmitted by the link information checking module 12 or the virtual communication module 14 is received. In contrast, when the protection system according to the present invention is divided in two or more terminals 10a and 10b, as shown in FIG. 4 (a block diagram showing an embodiment of an apparatus constituting a part of a local environment protection system according to the present invention), the virtual area is generated in the second terminal 10b when the second terminal 10b is booted or when a generation signal transmitted by the virtual communication module 14 is received.

The virtual communication module 14 is a communication program that executes browsing based on the connection path information checked and transferred by the link information checking module 12. The virtual communication module 14 executes typical browsing instead of a general communication module 11, and performs processing so that various types of external data received during the browsing process are executed in the virtual area.

The individual configurations of the local environment protection system will be described in detail below while describing the local environment protection method.

S10: Checking Link Information

A user connects to a specific server 20 or a mail server 30 using the general communication module 11, such as a typical web browser or the like, and receives and checks ‘content transmitted by the server 20,’ ‘mail data to be received by the mail server 30 over an external data network,’ or the like in advance. In this case, the data network may be the Internet, i.e., an external data network, or an Ethernet, i.e., an internal data network. As is well known, the general communication module 11 connects to the server 20 or the mail server 30, receives various types of content, such as a text, an image, a video, a sound, and the like, in the form of a page or an email, and then performs processing so that the following execution is to be performed on the data of the content in response to the manipulation of the user.

The link information checking module 12 checks the presence of the link information in the data of the content by checking the data of the content that is received by the general communication module 11, and then checks the connection path information in the link information after the link information has been checked. In this case, the connection path information may include a URL or the like, and the link information checking module 12 checks the presence and content of the URL.

The link information checking module 12 changes a communication protocol, corresponding to the connection path information that is checked as described above, at one time. The changing of the communication protocol is described using an example. When the link information checking module 12 identifies the connection path information, including a communication protocol dedicated to an internal or external communication network, such as http(s), mail or the like, the link information checking module 12 changes the communication protocol into vttp(s). For reference, although in the embodiment of the present invention, the example in which the http(s) is changed into the vttp(s) has been disclosed, the communication protocol is not limited thereto but may be changed into various forms.

Additionally, when the communication protocol of the URL is identified as the communication protocol dedicated to the external network, such as http(s) or the like, as the result of the checking of the connection path information by the link information checking module 12, the link information checking module 12 may selectively change the communication protocol.

S20: Selecting Content

The user selects content, which is posted by the operation of the general communication module 11, through clicking. As described above, the content may be a text, an image, a video, a sound, or the like. In the case of the text (a word, a sentence, or the like), the user executes corresponding link information by clicking the text; in the case of the image, the user executes corresponding link information by clicking the image; and in the case of the video, the user executes corresponding link information by clicking the video.

S30: Executing Virtual Communication Module

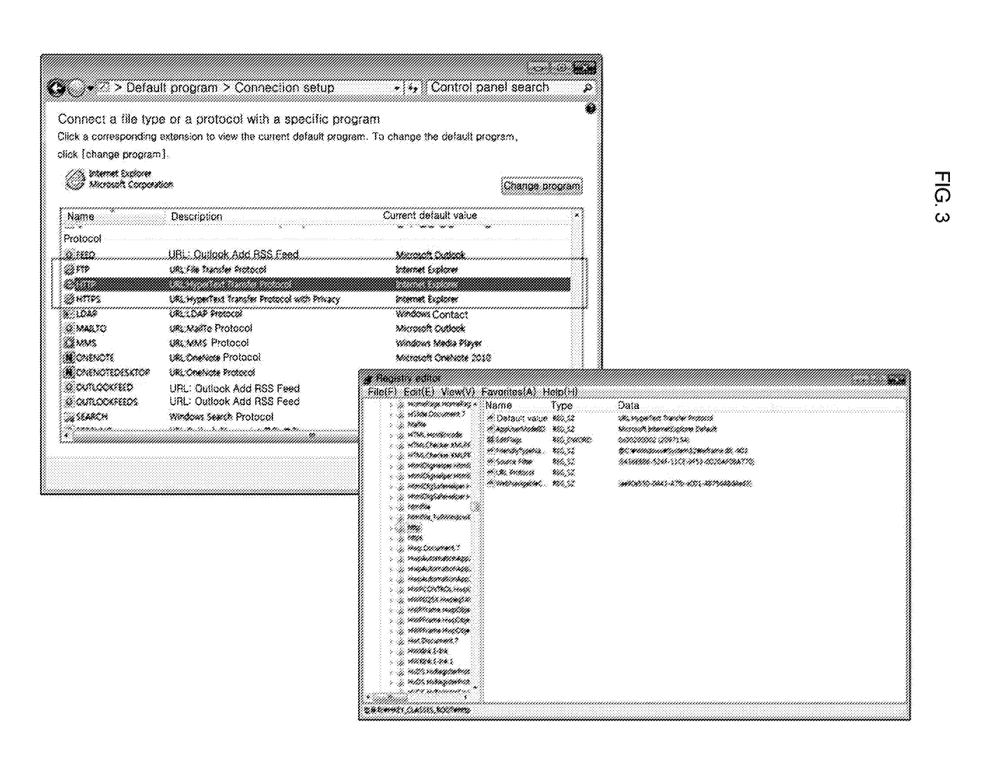

When the user clicks the content, the communication protocol of the connection path information included in the corresponding link information is in a changed state, and thus the general communication module 11 may not recognize the communication protocol. Accordingly, the general communication module 11 may not proceed to the following connection procedure based on the connection path information. In contrast, the virtual communication module 14 recognizes the communication protocol that has been changed by the link information checking module 12, and proceeds to the following connection procedure based on the registry of the terminal 10 related to the execution of the connection path information of the link information. For reference, as shown in FIG. 3 (an image that shows an example of editing a registry to operate the local environment protection system according to the present invention), the registry may be edited so that a designated communication protocol is connected to a specific program. Through this editing of the registry, the changed communication protocol of the connection path information is executed by the virtual communication module 14.

Meanwhile, the virtual area management module 13 generates an isolated virtual area in the terminal 10, and confines a connection based on the connection path information of the virtual communication module 14 so that the connection is performed within the virtual area. Through this process, the virtual communication module 14 is connected to the server 20 corresponding to the connection path information of the changed communication protocol, and confines the execution and storing of external data received over the external network so that they are performed only within the virtual area.

With regard to the virtual area in which the execution and storing of the external data are processed, the virtual area management module 13 may generate the virtual area when the link information checking module 12 identifies the link information in the data of the content and then transmits a signal to the virtual area management module 13, or may automatically generate the virtual area when the terminal 10 is booted or when the link information checking module 12, the virtual communication module 14, or the general communication module 11 is executed.

S40: Executing Content

The virtual communication module 14 performs the execution of the external data related to the corresponding connection path information within the virtual area. As an example, when the virtual communication module 14 connects to the designated server 20 based on the changed connection path information, the server 20 transmits various types of external data. In this case, when the received external data is page information such as a webpage or the like, the virtual communication module 14 executes and outputs the page information according to the page output function of the virtual communication module 14, and the page information is stored in the virtual area. Furthermore, when the received external data is video information, the virtual communication module 14 executes the video information by executing a dedicated video execution program installed on the terminal 10, and stores the video information, downloaded in real time, in the virtual area using a stream method. In addition, the virtual communication module 14 normally receives additional data linked to the external data, thereby allowing the additional data to be also stored and executed in the virtual area. Accordingly, when the additional data is malicious code, the malicious code does not affect a local environment because the malicious code is installed only in the virtual area through the driving process of the virtual communication module 14 configured to confine the execution range of the external data even when it is installed on the terminal 10.

S50: Terminating System

When the protection system is integrated in the terminal 10, the local environment protection system according to the present invention finally terminates the execution thereof in the case in which the terminal 10 is terminated or in the case in which the execution of the virtual communication module 14 or the link information checking module 12 is terminated. In contrast, when the protection system according to the present invention is divided in the first and second terminals 10a and 10b, the protection system finally terminates the execution thereof in the case in which the terminal 10 is terminated or in the case in which the execution of the virtual communication module 14 is terminated.

In this case, the virtual area management module 13 deletes the virtual area itself, or deletes the external data and the additional data stored in the virtual area. Finally, data received without permission through the link information is all deleted. Through this, the terminal 10 may securely perform communication without a burden related to data that enters from the outside.

FIG. 4 is a block diagram showing another embodiment of an apparatus constituting a part of a local environment protection system according to the present invention. The following description will be given with reference to this drawing.

The local environment protection system according to the present invention may be applied to a dedicated server (hereinafter the ‘mail server’) configured to process the transmission and reception of typical email, a messenger, or the like. In this case, the general communication module 11 is a dedicated application configured to connect to the mail server 30 and to process the transmission and reception of a mail file (hereinafter the ‘content’).

Meanwhile, in the present embodiment, the link information checking module 12 configured to check the presence of the link information in the content received by the mail server 30 is configured to be divided in the terminals 10a and 10b. For this purpose, the terminal according to the present embodiment is divided in the first terminal 10a configured to first receive and check the content before the mail server 30, and the second terminal 10b configured to be manipulated by the user. The link information checking module 12 is configured in the first terminal 10a. Typically, the first terminal 10a is a security server, and may be set up as separate hardware.

Finally, when the user connects to the mail server 30 through the general communication module 11, the mail server 30 starts to receive the content, and then the link information checking module 12 of the first terminal 10a first checks the content received over the data network and changes the connection path information of the link information included in the content.

Accordingly, the link information in the content provided by the mail server 30 includes the connection path information in which the communication protocol is changed. Through this, the apparatus that may recognize the communication protocol changed in the second terminal 10b is confined to the virtual communication module 14 according to the present invention.

Although the above description has been given with reference to the preferred embodiments of the present invention in the above detailed description of the present invention, it will be appreciated by those skilled in the corresponding art or those having ordinary knowledge in the corresponding art that the present invention may be modified and altered in various manners without departing from the spirit and technical scope of the present invention that are set forth in the following claims.

1. A local environment protection method for a terminal against malicious code in link information, the method comprising:
a link information checking step of checking presence of link information of content that is to be received by a general communication module and then changing a communication protocol set in connection path information of the link information;
a virtual communication module execution step of checking, by a virtual communication module, content selection of a user, and executing, by the virtual communication module, a communication connection via a connection path of the changed communication protocol; and
a content execution step of storing external data, received by the virtual communication module via the connection path, in a virtual area generated in a terminal.

2. The local environment protection method of claim 1, further comprising, before the content execution step, a step of checking, by a virtual area management module, whether the terminal or the virtual communication module is executed, and generating, by the virtual area management module, the virtual area in the terminal.

3. The local environment protection method of claim 2, further comprising, after the content execution step, a system termination step of checking, by the virtual area management module, termination of the terminal or the virtual communication module, and then deleting, by the virtual area management module, the external data stored in the virtual area.

4. A local environment protection system for a terminal against malicious code in link information, the system comprising:
a link information checking module configured to check presence of link information of content data that is to be received by a general communication module, and to change a communication protocol set in connection path information of the link information; and
a virtual communication module configured to check content selection of a user and execute a communication connection via a connection path of the changed communication protocol, and to store external data, received via the connection path, in a virtual area generated in a terminal.

5. The local environment protection system of claim 4, further comprising a virtual area management module configured to check whether the terminal or the virtual communication module is executed, and to generate the virtual area in the terminal.

6. The local environment protection system of claim 5, wherein the virtual area management module checks termination of the terminal or the virtual communication module, and deletes the external data stored in the virtual area.

7. The local environment protection system of claim 4, wherein:
the terminal comprises a first terminal configured to receive content before a mail server, and a second terminal configured so that it is manipulated by the user;
the first terminal comprises the link information checking module; and
the second terminal comprises the virtual communication module and the virtual area management module.
